(19) United States
(12) Patent Application Publication
(10) Pub. No.: US 2022/0121664 A1
(43) Pub. Date: Apr. 21, 2022

(54) FORECASTING FOR TIME SERIES WITH LIMITED DATA

(71) Applicant: ActionIQ, Inc., New York, NY (US)

(72) Inventors: Jonathan Mark Eskreis-Winkler, New York, NY (US); Kia Dalili, New York, NY (US)

(21) Appl. No.: 17/071,467

(22) Filed: Oct. 15, 2020

(51) Int. Cl. G06F 16/2458

(52) U.S. Cl. CPC G06F 16/2474; G06Q 10/10

(57) ABSTRACT

Systems and techniques are provided for forecasting for time series with limited data. A computing device may determine a distance between the long-term time series or section and a short-term time series may be determined for each long-term time series and section in a repository. The computing device may determine which of the long-term time series and sections from the repository has the shortest distance between that long-term series or section and the short-term time series. The computing device may generate forecasted data points for the short-term time series based on the long-term time series or section determined to have the shortest distance between that long-term time series or section and the short-term time series. The computing device may store the forecasted data points for the short-term time series with the short-term time series.

### BACKGROUND

Data from a time series may be used to generate a forecast for that time series. The accuracy of the forecast may improve as more data is added to the time series. Some time series may only have data that has been gathered for a short period of time before a forecast is made, limiting that amount of data available to make the forecast and possibly reducing the accuracy of the forecast.

### BRIEF SUMMARY

According to implementations of the disclosed subject matter, A computing device may determine a distance between the long-term time series or section and a short-term time series may be determined for each long-term time series and section in a repository. The computing device may determine which of the long-term time series and sections from the repository has the shortest distance between that long-term series or section and the short-term time series. The computing device may generate forecasted data points for the short-term time series based on the long-term time series or section determined to have the shortest distance between that long-term time series or section and the short-term time series. The computing device may store the forecasted data points for the short-term time series with the short-term time series.

Systems and techniques disclosed herein may allow for forecasting for time series with limited data. Additional features, advantages, and embodiments of the disclosed subject matter may be set forth or apparent from consideration of the following detailed description, drawings, and claims. Moreover, it is to be understood that both the foregoing summary and the following detailed description are examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows an example system suitable for forecasting for time series with limited data according to an implementation of the disclosed subject matter.

FIG. 2 shows an example arrangement suitable for forecasting for time series with limited data according to an implementation of the disclosed subject matter.

FIG. 3A shows an example visualization suitable for forecasting for time series with limited data according to an implementation of the disclosed subject matter.

FIG. 3B shows an example visualization suitable for forecasting for time series with limited data according to an implementation of the disclosed subject matter.

FIG. 3C shows an example visualization suitable for forecasting for time series with limited data according to an implementation of the disclosed subject matter.

FIG. 3D shows an example visualization suitable for forecasting for time series with limited data according to an implementation of the disclosed subject matter.

FIG. 3E shows an example visualization suitable for forecasting for time series with limited data according to an implementation of the disclosed subject matter.

FIG. 4 shows an example visualization suitable for forecasting for time series with limited data according to an implementation of the disclosed subject matter.

FIG. 5A shows an example visualization suitable for forecasting for time series with limited data according to an implementation of the disclosed subject matter.

FIG. 5B shows an example visualization suitable for forecasting for time series with limited data according to an implementation of the disclosed subject matter.

FIG. 6 shows an example arrangement suitable for forecasting for time series with limited data according to an implementation of the disclosed subject matter.

FIG. 7 shows a computer according to an embodiment of the disclosed subject matter.

FIG. 8 shows a network configuration according to an embodiment of the disclosed subject matter.

### DETAILED DESCRIPTION

According to embodiments disclosed herein, forecasting for time series with limited data may be used to generate forecasts for time series that have a limited amount of data by using a different time series that has more data. A time series may be a short-term time series, having few data points. A repository may include data for that may from, and may be used to build, time series that may be long-term time series, having greater amounts of data points than the short-term time series. The short-term time series may be compared to long-term time series from and built with data from the repository to determine a long-term time series that best matches the short-term time series. The long-term time series which best matches the short-term time series may be used to generate a forecast for the long-term time series. The forecast generated for the long-term time series may be used to generate a forecast for the short-term time series.

A time series may be a short-term time series, having few data points. The short-term time series may include data points generated over any suitable period of time at any suitable intervals that include measurements of any suitable metric of any suitable type. Metrics measured to generate the data points of a time series may include, for example, actions taken by a computer system, such as the sending of emails, a recurring aspect of a computer system, including hardware or software, such as a hard drive temperature, or any other metric which may be measured, such as the sale of goods. A short-term time series may include fewer data points, for example, with data points having been generated for an overall period of time that is shorter compared to the interval used by the short-term time series. For example, a short-term time series may include data points that generated based on measuring the revenue generated by a category of items sold by a business over time period of 12 weeks, with the data points being generated at an interval of once per week, resulting in the short-term time series having only 12 data points after 12 weeks. A short-term time series that includes data points generated at an interval of once an hour may include data points generated over 24 hours, so that the short-term time series only has 24 data points. The short-term time series may be generated in any suitable manner by any suitable computing device or system, and may be generated in real-time, for example, with measurements to generate data points occurring at the intervals of the time series, or retrospectively, for example, with measurements to generate data points occurring after some number of intervals have passed. For example, data points for the revenue generated by the sale of a category of products by a business may be generated using data stored in a database system used by the business, and may be generated at the interval of the time series, for example, once per week.

A repository may include data for various time series that may be long-term time series, having greater numbers of data points than the short-term time series Data in the repository may be data points from long-term time series received from any source, and may include any suitable number of data points measuring any suitable metrics generated at any suitable intervals over any suitable periods of times. Different long-term time series stored in the time series repository may have different numbers of data points measuring different metrics and generated at different intervals over time periods of different lengths. For example, the time series repository may include a long-term time series with data points that were generated by measuring the revenue generated by a category of product sold by a business at once week intervals over a period of five years, including 260 data points, and a long-term time series with data points that were generated by measuring the temperature of a hard drive in a server system at 10 minute intervals over a period of 140 days, including 20160 data points. Data in the repository may also include data points that were not generated as part of any particular time series.

The short-term time series may be compared to long-term time series from or built from data in the repository to determine a long-term time series that best matches the short-term time series. The short-term time series may not have enough data points to allow for accurate forecasting. For example, time series that includes data points generated by measuring certain metrics, such as sales, may exhibit seasonality or periodicity. If a time series is short-term, not enough data points may exist to evaluate the seasonality or periodicity of the time series. To generate a forecast for the short-term time series, for example, generating estimates for future data points for the short-term time series, the short-term time series may be compared to a long-term time series from or built from data in the repository to determine a long-term time series that best matches the short-term time series.

The short-term time series may be compared to any suitable long-term time series from or built from data in the repository. For example, the repository may include data points for a long-term time series generated by measuring total revenue of a business at one week intervals over a period of five years and long-term time series that measure the revenue of various categories of products sold by the business over a time period of five years at one week intervals. The short-term time series with data points based generated using measurements of the revenue of a new product category sold by the business over a time period of one month at once week intervals may be compared against these long-term time series to determine which is the best match for the short-term time series. Additional long-term time series may be built using data points from the repository, for example, through any suitable combination of data points, and the short-term time series may be compared against the additional long-term time series as well.

The comparison between a short-term time series and a long-term time series may be performed in any suitable manner. For example, the data points of the short-time series may be aligned with data points from the long-term time series. The distance between aligned data points from the short-term and long-term time series may be measured. The total distance between the short-term and long-term time series may be determined using the measurements of the distance between the aligned data points from the short-term and long-term time series, for example, as in a Euclidean distance measurement. Any other suitable measurement of distance may also be used between the short-term and long-term time series, including, for example, Fréchet distance. The measurement of distance between a short-term and long-term time series may use scaling or normalization to adjust for a difference in the scale of the magnitude between the data points of the long-term time series and the short-term time series. For example, if the data points of the long-term time series are measurements of an overall revenue metric for a business, while the data point of the short-term time series are measurements of a revenue metric for a specific category of products sold by a business, the data points of the long-term time series may need to be scaled down or normalized before the distance between the short-term and long-term time series are determined.

The data points of a short-term time series and long-term time series may be aligned for comparison is any suitable manner, including, for example, based on the dates and time of the data points. Every data point may have any associated timestamp, which may indicate the date and time the data point was generated, as well as the period of time covered by the measurement of the metric used to generate the data point. The timestamps may be used to align the data points from short-term and long-term time series before determining the distance between the short-term and long-term time series. For example, a short-term time series may have data points that were generated once per week over the previous 12 weeks and a long-term time series may have data points that were generated once per week over the previous 260 weeks, with the last data point from both the short-term and long-term time series having been generated the same week. The last data point from the short-term time series may be aligned with the last data point from the long-term time series, and all other data points from the short-term time series may similarly be aligned with a data point from the long-term time series from the same week. This may result in the 12 data points of the short-term time series being aligned with the 12 most recent data points from the long-term time series. The distance between the short-term and long-term time series may then be determined based on the 12 aligned data points from each time series.

Time shifts may be used to align data points from a short-term time series with data points from a long-term time series. For example, a short-term time series may have data points that were generated once per week over the previous 12 weeks and a long-term time series may have data points that were generated once per week over the previous 260 weeks, with the last data point from both the short-term and long-term time series having been generated the same week. In addition to aligning the last data point of the short-term and long-term time series, the short-term time series may be time shifted so that the last data point of the short-term time series aligns with an earlier data point of the long-term time series. The time shift used may be based on, for example, the time period covered by the long-term time series and the seasonality or periodicity of the long-term time series. For example, if the long-time series with 260 data points over 260 weeks exhibits monthly periodicity, the short-term time series may be time shifted by some number of years, aligning the last data point of the short-term time series with a data point from the long-term time series that was generated on the same date some number of years ago. For example, the last data point of the short-time series may be aligned with a data point from the long-term time series that was generated on the same date as the data point from the short-term time series but one year, two years, or three years prior. The other data points in the short-term time series may be similarly aligned to data points from the long-term time series from their same dates, but some number of years prior. This may result in a single long-term time series being treated as multiple long-term time series for the purpose of determining a distance between the long-term time series and a short-term time series, with the short-term data series being compared different sections of the long-term time series. For example, each year of the five years of the long-term time series with 260 weeks of weekly data points may be treated as a separate long-term time series, and the distance between a short-term time series and each of the five yearly time series of the long-term time series may be determined.

The long-term time series which best matches the short-term time series may be used to generate a forecast for the long-term time series. The long-term time series that best matches the short-term time series may be the long-term time series for which the determined distance between itself and the short-term time series was the shortest. This long-term time series may be a companion series for the short-term time series. A forecast may be generated for this companion series in any suitable manner, using any suitable statistical techniques, and may extend any suitable length of time into the future. For example, if the companion series was aligned with the short-term time series so that there were no data points in the companion series after the last data point of the short-term time series, forecasting techniques, including statistical techniques and machine learning techniques, may be used to forecast any suitable number of future data points for the companion time series, generating forecasted data points for the companion series. If the companion series was aligned with the short-term time series so that there were data points in the companion series after the last data point of the short-term time series, these data points of the companion series after the last data point of the short-term time series may serve as the forecasted data points for the companion series, with additional forecasted data points being generated if necessary to extend the forecast beyond the number of data points available in the companion series after the data point of the companion series that is aligned with the last data point of the short-term time series.

The forecast generated for the long-term time series may be used to generate a forecast for the short-term time series. The forecasted data points for the long-term time series that is the companion series for the short-term time series may be used to generated forecasted data points for the short-term time series. For example, the forecasted data points for the companion time series may be scaled to match the scale of the short-term time series, resulting in forecasted data points for the short-term time series. The forecasted data points may also be adjusted in any other suitable manner to generate the forecasted data points for the short-term time series. For example, the distance that was determined between the short-term time series and the companion series may be used to adjust the forecasted data points for the companion series when generating the forecasted data points for the short-term time series so that the determined distance is maintained between the forecasted data points for the companion series and the determine data points for the short-term time series.

The forecasted data points for the short-term time series may be used in any suitable manner. For example, they may be stored in a database with the short-term time series or separately from the short-term time series, or may be presented to a user through a user interface such as display.

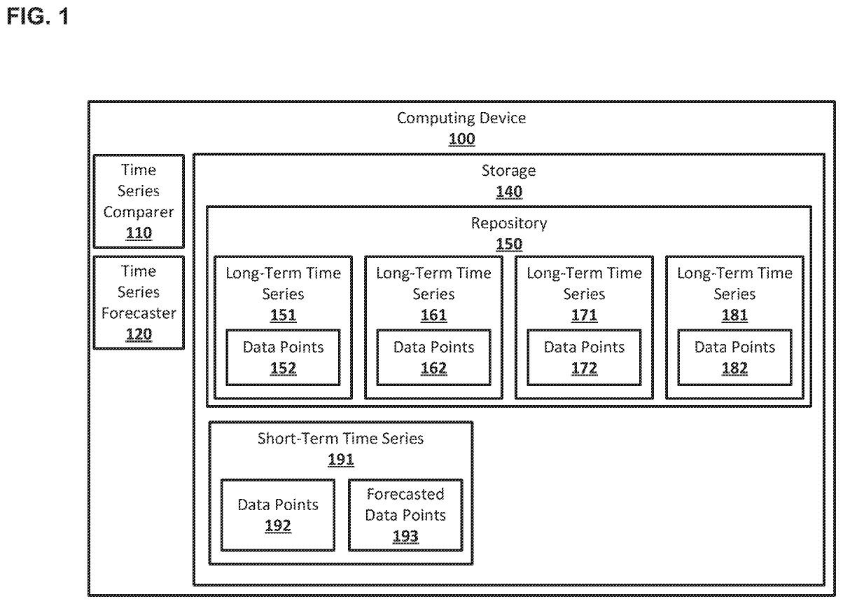

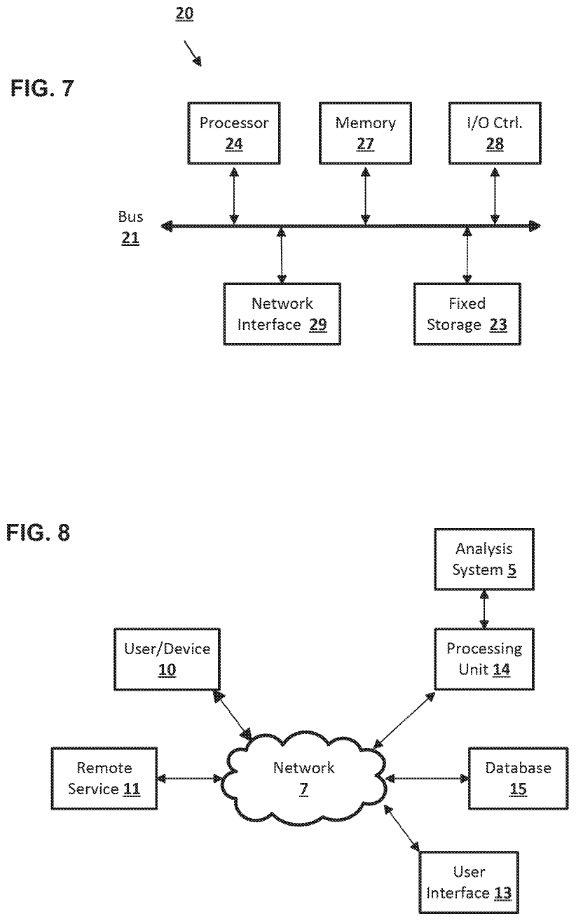

FIG. 1 shows an example system suitable for forecasting for time series with limited data according to an implementation of the disclosed subject matter. A computing device 100 may include a time series comparer 110, a time series forecaster 120, and storage 140. The computing device 100 may be any suitable device, such as, for example, a computer 20 as described in FIG. 7, for implementing the time series comparer 110, the time series forecaster 120, and the storage 140. The computing device 100 may be a single computing device, or may include multiple connected computing devices, and may be, for example, a laptop, a desktop, an individual server, a server farm, or a distributed server system, or may be a virtual computing device or system. The computing device 100 may be part of a computing system and network infrastructure, or may be otherwise connected to the computing system and network infrastructure. The time series comparer 110 may be any suitable combination of hardware and software for comparing time series to determine the distance between two time series. The time series forecaster 120 may be any suitable combination of hardware and software for generating forecasted data points for a time series. The storage 140 may be any suitable combination of hardware and software for implementing any suitable combination of volatile and non-volatile storage, which may store data for the computing device 100.

The time series comparer 110 may be any suitable combination of hardware and software for comparing time series to determine the distance between two time series on the computing device 100. The time series comparer 110 may compare short-term time series, such as the short-term time series 191 to long-term time series from a repository, such as long-term time series 151, 161, 171, and 181 from repository 150, to determine the distances between the short-term time series and the long-term time series. The time series comparer 110 may determine which long-term time series from a repository, for example, the repository 150, has the shortest distance between itself and a short-term time series such as the short-term time series 191. The time series comparer 110 may send the determined long-term time series with the shortest distance between itself and the short-term time series to the time series forecaster 120 as a companion series for the short-term time series.

The time series forecaster 120 may be any suitable combination of hardware and software for generating forecasted data points for a time series. The time series forecaster 120 may, for example, generate forecasted data points for a long-term time series received from the time series comparer 110 as a companion series to a short-term time series. The time series forecaster 120 may then use the forecasted data points for the long-term time series to generate forecasted data points for the short-term time series. The time series forecaster 120 may use any suitable type of forecasting to generate forecasted data points.

The storage 140 may be any suitable storage hardware connected to the computing device 100. For example, the storage 140 may be a component of the computing device, such as a magnetic disk, flash memory module or solid state disk, or may be connected to the computing device 100 through any suitable wired or wireless connection. The storage 140 may be a local storage, i.e., within the environment within which the computing device 100 operates, or may be partially or entirely operated on a remote server. The storage 140 may store long-term time series, such as the long-term time series 151, 161, 171, and 181, in the repository 150. The repository 150 may be any suitable combination of hardware and software for storing long-term time series and their associated data points, and may be, for example, a database or database system. The long-term time series 151, 161, 171, and 181 may include data points 152, 162, 172, and 182. The data points 152, 162, 172, and 182 may have been generated over any suitable periods of time, at any suitable intervals, based on the measurement of any suitable metrics. The data points for different time series may have been generated over different periods of time and different intervals and may include measurements of different metrics. For example, the data points 152 of the long-term time series 151 may have been generated over 60 months at an interval of once per month, and may include measurement of the overall revenue of a business. The data points 162 of the long-term time series 161 may have been generated over one month at an interval of once very time minutes, and may include measurements of the temperature of a hard drive in a server system. The time series in the repository 150, such as long-term time series 151, 161, 171, and 181, may have been received at the computing device 100 from any suitable source, including, for example, from software or hardware running on the computing device 100 and generating data points, from a storage accessible to the computing device 100, or from another computing device or system. Time-series may be added to the repository 150 at any time. Additional data points may be added to the data points for a time series in the repository 150 as they are received at the computing device 100, which may be as they are generated for their respective time series, or may be in batches. For example, a new data point may be added to the data points 152 at the end of every month that may include the measurement of the overall revenue of the business for that month, or new data points may be added to the data points 152 in batches of, for example, six, every six months. Time series stored in the repository 150 may be long-term time series, as they may have enough data points relative to the time period over which the data points have been generated to allow any seasonality or periodicity of the time series to be detected.

The storage 140 may store the short-term time series 191. The short-time series 191 may include data points 192, which may have been generated over any suitable period of time, at any suitable interval, based on the measurement of any suitable metric. For example, the data points 192 of the short-term time series 191 may include measurements generated over nine months at an interval of once a month of the revenue generated by a product category sold by a business. The data points 192 of the short-term data series 191 may be received at the computing device 100 from any suitable source, including, for example, from software or hardware running on the computing device 100 and generating data points, from a storage accessible to the computing device 100, or from another computing device or system. The short-term time series 191 may also include forecasted data points 193. The forecasted data points 193 may be data points for the short-term time series 191 generated by the time series forecaster 120, and may forecast the measurements for data points for the short-term time series 191 for some period of time into the future, going beyond the time period for which the data points 192 have been generated from actual measurements of the metric. New data points may be added to the data points 192 at any suitable time, such as, for example, as they are generated and received at the computing device 100, and forecasted data points 193 may become obsolete when data points are generated from actual measurements of the metric for the time periods covered by the forecasted data points 193. The data points 192 of the short-term time series 191 may include fewer data points than any of the data points 152, 162, 172, and 182 of the long-term time series 151, 161, 171, and 181 in the repository 150. The number of data points in the data points 192 may be make forecasting for the short-term time series 191, for example, by the time series forecaster 120, unreliable if based only on the data points 192.

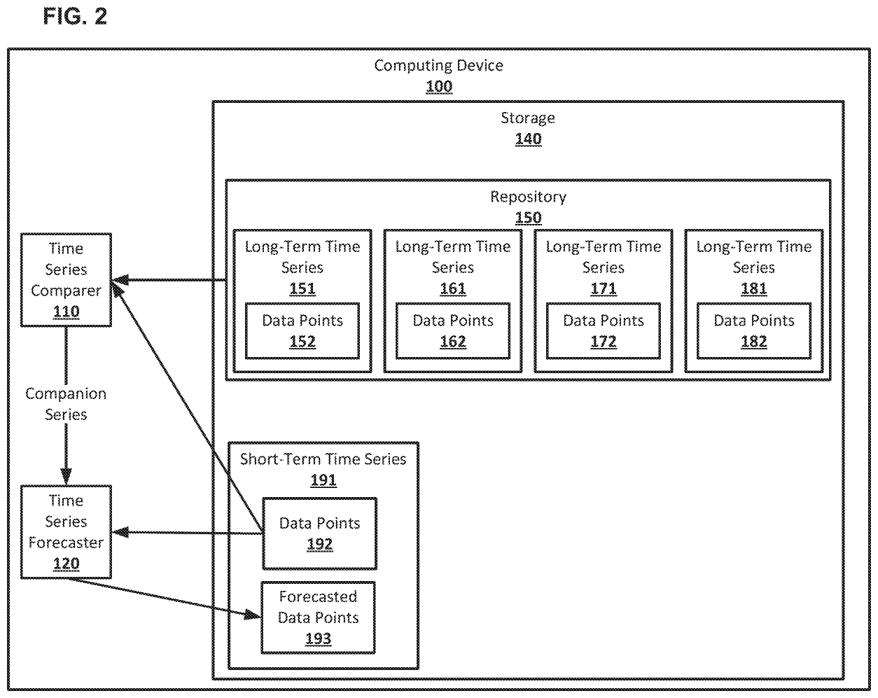

FIG. 2 shows an example arrangement suitable for forecasting for time series with limited data according to an implementation of the disclosed subject matter. The time series comparer 110 may compare the long-term time series in the repository 150, such as the long-term time series 151, 161, 171, and 181, to the short-term time series 191 to determine the distance between each of the long-term time series and the short-term time series 191. If a long-term time series, such as the long-term time series 151, has enough data points covering a long enough period of time, the time series comparer 110 may determine the distance between different sections of that long-term time series and the short-term time series 191. For example, the long-term time series 151 may include 60 monthly data points and the short-term time series 191 may include 10 monthly data points. The time series comparer 110 may determine a distance between the short-term time series 191 and the long-term time series 151 by aligning the last data points of the the long-term time series 151 and the short-term time series 191 so that the last data point from the long-term time series 151 is aligned with the last data point from the short-time series 191. The time series comparer may then determine another distance by aligning the last data point from the short-term time series 191 with a data point from the long-term time series 151 from 12 months ago, for example, the 48^{th} data point of the data points 152. The time series comparer 110 may then determine another distance by aligning the last data point from the short-term time series 191 with a data point from the long-term time series 151 from 24 months ago, for example, the 36^{th} data point of the data points 152. The time series comparer 110 may then determine another distance by aligning the last data point from the short-term time series 191 with a data point from the long-term time series 151 from 36 months ago, for example, the 24^{th} data point of the data points 152. The time series comparer 110 may then determine another distance by aligning the last data point from the short-term time series 191 with a data point from the long-term time series 151 from 48 months ago, for example, the 12^{th} data point of the data points 152. The time series comparer 110 may determine the distance between long-term time series from the repository 150 and short-term time series 191 in any suitable manner, including, for example, using Euclidean of Fréchet distance.

The time series comparer 110 may determine which long-term time series or section therefor from the repository 150 has the shortest distance between itself and the short-term time series 191. The time series comparer 110 may send the determined long-time series that has, or includes the section that has, the shortest distance between itself and the short-term time series 191 to the time series forecaster 120 as a companion series to the short-term time series 191.

The time series forecaster 120 may use the companion series and the data points 192 of the short-term time series 191 to generate the forecasted data points 193 for the short-term time series 191. The forecasted data points 193 may be generated in any suitable manner. For example, if the distance between the companion series and the short-term time series 191 was determined by aligning the last data points of the companion series and the short-term time series 191, the time series forecaster 120 may generate forecasted data points for the companion series. The forecasted data points for the companion series may then be used to generate the forecasted data points 193, for example, scaling and adjusting the forecasted data points for the companion series based on the data points 192 of the short-term time series 191. If the distance between the companion series and the short-term time series 191 was determined by aligning the an earlier data point of the companion series and the last data point of short-term time series 191, the time series forecaster 120 may use data points of the companion series that follow the data point aligned with the last data point of the short-term time series 191 to generate the forecasted data points 193.

The forecasted data points 193 may be forecasted, or predicted, measurements for the metric measured to generate the data points 191. The time series forecaster 120 may generate any suitable number of data points as the forecasted data points 193. For example, the time series forecaster 120 may generate forecasted data points for some specified number of intervals of the short-time series 191. The forecasted data points 193 may be stored with the short-term time series 191, and may be used in any suitable manner, including, for example, being displayed to a user of the computing device 100. The forecasted data points 193 may be stored for any suitable period of time.

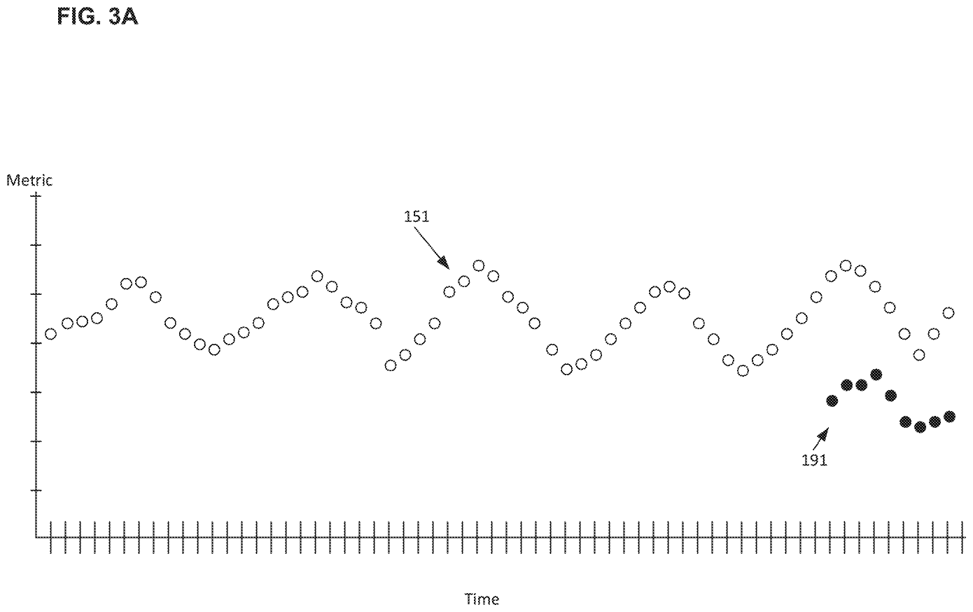

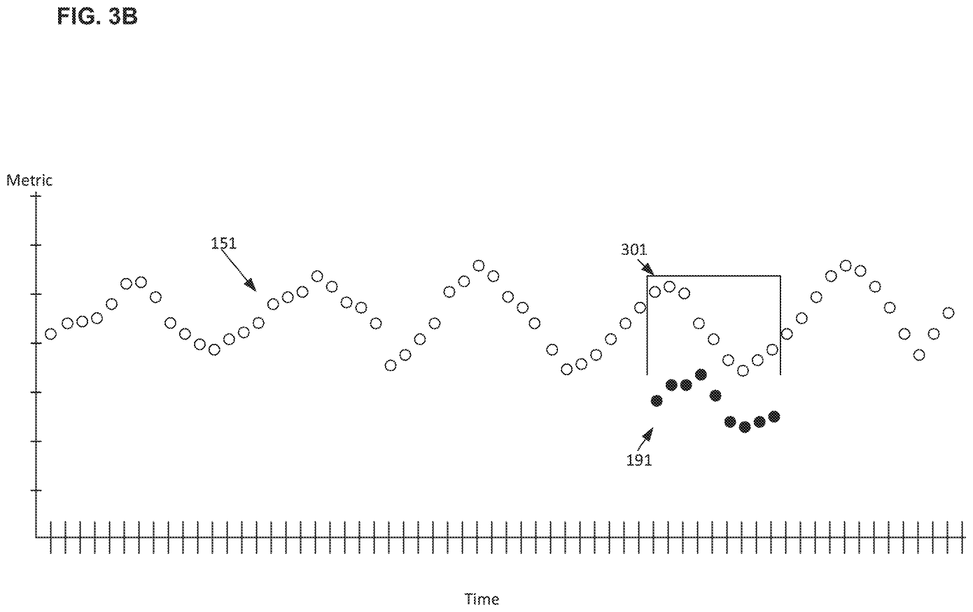

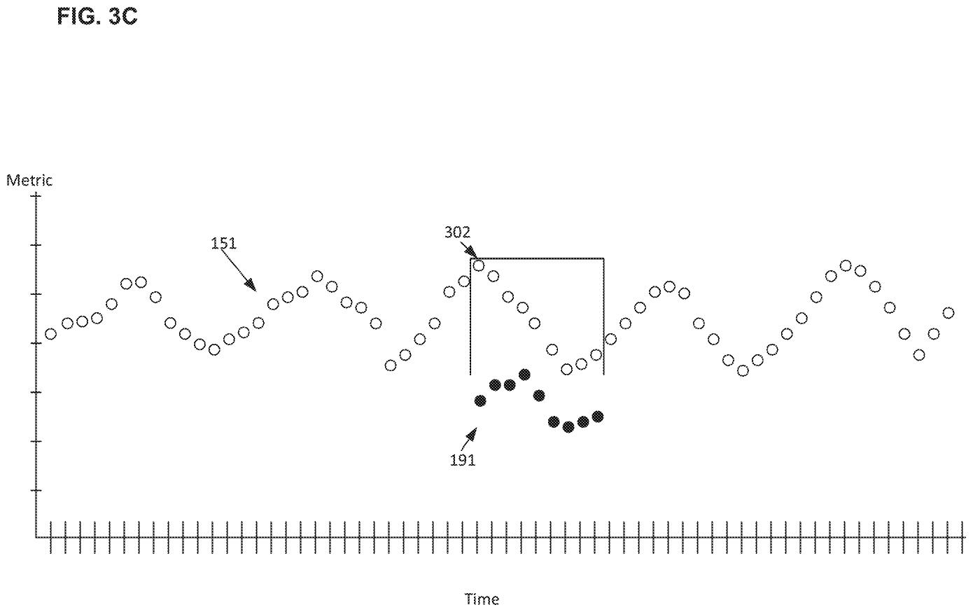

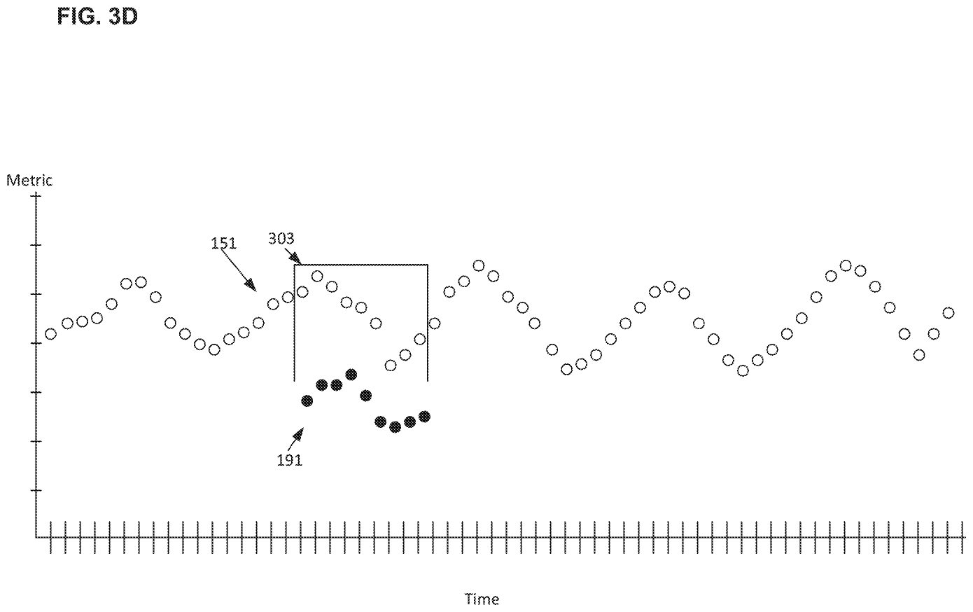

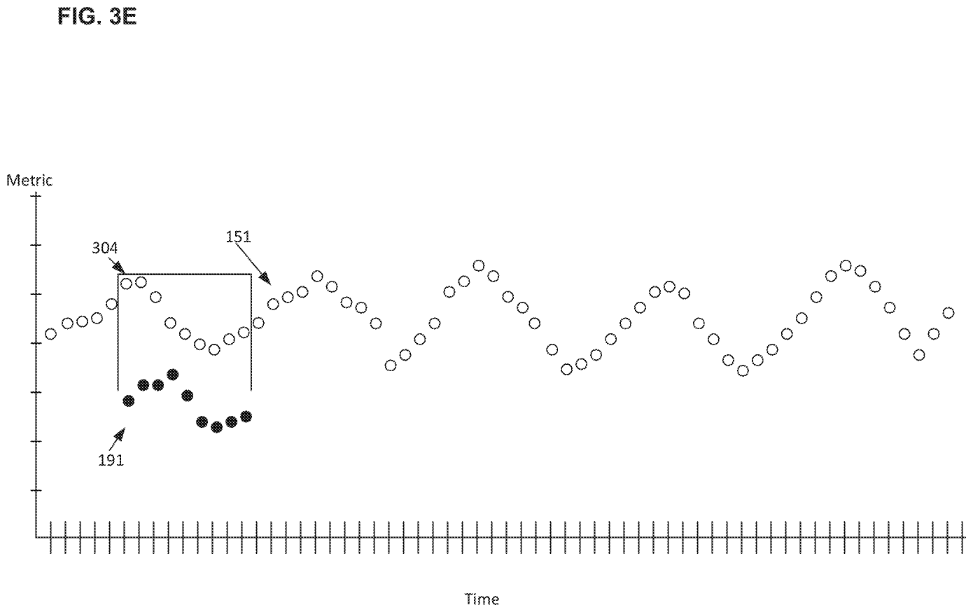

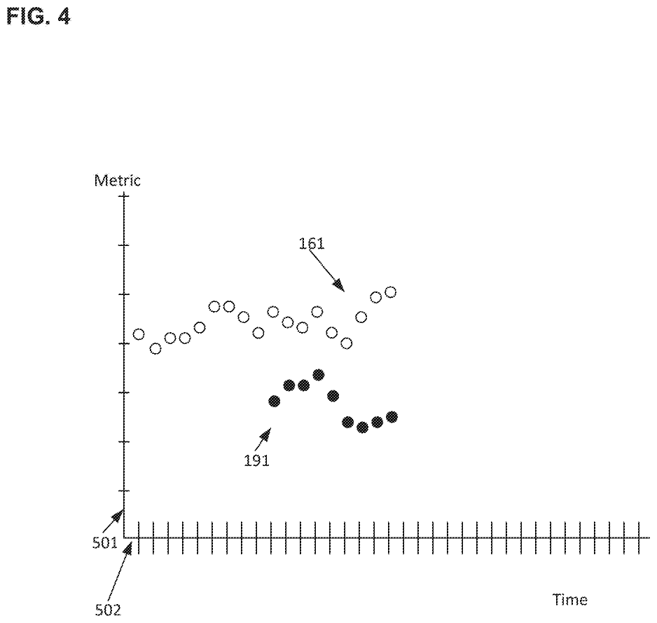

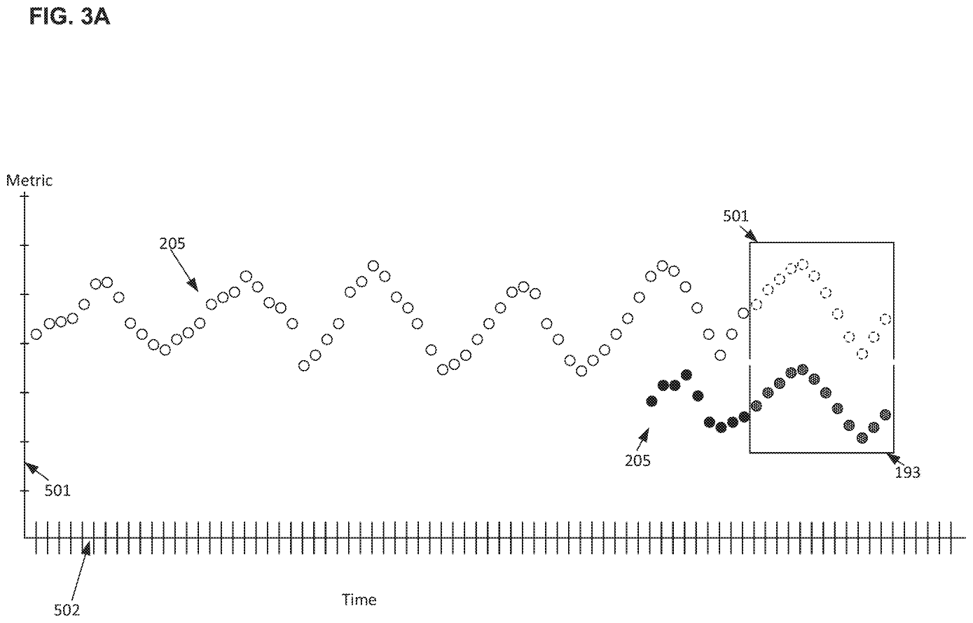

FIG. 3A shows an example visualization suitable for forecasting for time series with limited data according to an implementation of the disclosed subject matter. The time series comparer 110 may compare the long-term time series 151 to the short-term time series 191 to determine the distance between them. The data points 192 for the short-term time series 191 may include nine data points, which may be monthly measurements of the metric of the short-term time series 191. The data points 152 for the long-term time series 151 may include 62 data points, which may be monthly measurements of the metric of the long-term time series 151.

The time series comparer 110 may align the last data point of the long-term time series 151 from the data points 152 with the last data point of the short-term time series 191 from the data points 192. This may result in the nine data points of the short-term time series 191 being aligned with the last nine data points of the long-term time series 151. The time series comparer 110 may determine the distance between the long-term series 151 and the short-term time series 191 based on data points that are aligned between the time series, and may not use the 53 data points of the long-term series 151 that are not aligned with any data points of the short-term time series 191. The determined distance may be used by the time series comparer 110 when determining which long-term time series or section thereof from the repository 150 should be used as the companion series for the short-term time series 191.

FIG. 3B shows an example visualization suitable for forecasting for time series with limited data according to an implementation of the disclosed subject matter. The time series comparer 110 may compare a section 301 of the long-term time series 151 to the short-term time series 191 to determine the distance between them. The section 301 of the long-term time series 151 may include nine consecutive data points with the last data point of the section 301 being from 12 months prior to the last data point of the long-term time series 151. This data point may be, for example, the 50^{th} data point in the long-term time series 151.

The time series comparer 110 may align the last data point of the section 301 of the long-term time series 151 with the last data point of the short-term time series 191 from the data points 192. This may result in the nine data points of the short-term time series 191 being aligned with the nine data points of the section 301, which may be the 42^{nd} through 50^{th} data points of the long-time series 151. The time series comparer 110 may determine the distance between the section 301 of the long-term series 151 and the short-term time series 191 based on the aligned data points, and may not use the 53 data points of the long-term series 151 that are not in section 301 and are therefore not aligned with any data points of the short-term time series 191. The determined distance may be used by the time series comparer 110 when determining which long-term time series or section thereof from the repository 150 should be used as the companion series for the short-term time series 191.

FIG. 3C shows an example visualization suitable for forecasting for time series with limited data according to an implementation of the disclosed subject matter. The time series comparer 110 may compare a section 302 of the long-term time series 151 to the short-term time series 191 to determine the distance between them. The section 302 of the long-term time series 151 may include nine consecutive data points with the last data point of the section 302 being from 24 months prior to the last data point of the long-term time series 151. This data point may be, for example, the 38^{th} data point in the long-term time series 151.

The time series comparer 110 may align the last data point of the section 302 of the long-term time series 151 with the last data point of the short-term time series 191 from the data points 192. This may result in the nine data points of the short-term time series 191 being aligned with the nine data points of the section 302, which may be the 30^{th} through 38^{th} data points of the long-time series 151. The time series comparer 110 may determine the distance between the section 302 of the long-term series 151 and the short-term time series 191 based on the aligned data points, and may not use the 53 data points of the long-term series 151 that are not in section 302 and are therefore not aligned with any data points of the short-term time series. The determined distance may be used by the time series comparer 110 when determining which long-term time series or section thereof from the repository 150 should be used as the companion series for the short-term time series 191.

FIG. 3D shows an example visualization suitable for forecasting for time series with limited data according to an implementation of the disclosed subject matter. The time series comparer 110 may compare a section 303 of the long-term time series 151 to the short-term time series 191 to determine the distance between them. The section 303 of the long-term time series 151 may include nine consecutive data points with the last data point of the section 303 being from 36 months prior to the last data point of the long-term time series 151. This data point may be, for example, the 26^{th} data point in the long-term time series 151.

The time series comparer 110 may align the last data point of the section 303 of the long-term time series 151 with the last data point of the short-term time series 191 from the data points 192. This may result in the nine data points of the short-term time series 191 being aligned with the nine data points of the section 303, which may be the 18^{th} through 26^{th} data points of the long-time series 151. The time series comparer 110 may determine the distance between the section 303 of the long-term series 151 and the short-term time series 191 based on the aligned data points, and may not use the 53 data points of the long-term series 151 that are not in section 303 and are therefore not aligned with any data points of the short-term time series. The determined distance may be used by the time series comparer 110 when determining which long-term time series or section thereof from the repository 150 should be used as the companion series for the short-term time series 191.

FIG. 3E shows an example visualization suitable for forecasting for time series with limited data according to an implementation of the disclosed subject matter. The time series comparer 110 may compare a section 304 of the long-term time series 151 to the short-term time series 191 to determine the distance between them. The section 304 of the long-term time series 151 may include nine consecutive data points with the last data point of the section 304 being from 48 months prior to the last data point of the long-term time series 151. This data point may be, for example, the 14^{th} data point in the long-term time series 151.

The time series comparer 110 may align the last data point of the section 304 of the long-term time series 151 with the last data point of the short-term time series 191 from the data points 192. This may result in the nine data points of the short-term time series 191 being aligned with the nine data points of the section 304, which may be the 6th through 14^{th} data points of the long-time series 151. The time series comparer 110 may determine the distance between the section 304 of the long-term series 151 and the short-term time series 191 based on the aligned data points, and may not use the 53 data points of the long-term series 151 that are not in section 304 and are therefore not aligned with any data points of the short-term time series. The determined distance may be used by the time series comparer 110 when determining which long-term time series or section thereof from the repository 150 should be used as the companion series for the short-term time series 191.

FIG. 4 shows an example visualization suitable for forecasting for time series with limited data according to an implementation of the disclosed subject matter. The time series comparer 110 may compare the long-term time series 161 to the short-term time series 191 to determine the distance between them. The data points 192 for the short-term time series 191 may include nine data points, which may be monthly measurements of the metric of the short-term time series 191. The data points 162 for the long-term time series 161 may include 18 data points, which may be monthly measurements of the metric of the long-term time series 161.

The time series comparer 110 may align the last data point of the long-term time series 161 from the data points 162 with the last data point of the short-term time series 191 from the data points 192. This may result in the nine data points of the short-term time series 191 being aligned with the last nine data points of the long-term time series 161. The time series comparer 110 may determine the distance between the long-term series 161 and the short-term time series 191 based on data points that are aligned between the time series, and may not use the nine data points of the long-term series 161 that are not aligned with any data points of the short-term time series 191. The determined distance may be used by the time series comparer 110 when determining which long-term time series or section thereof from the repository 150 should be used as the companion series for the short-term time series 191. The time series comparer 110 may not compare any additional sections of the long-term time series 161 with the short-term time series 191, as the long-term time series 161 may not have enough data points to allow the short-term time series 191 to be shifted backwards by an appropriate amount of time based on the intervals and seasonality or periodicity of the long-term time series 161.

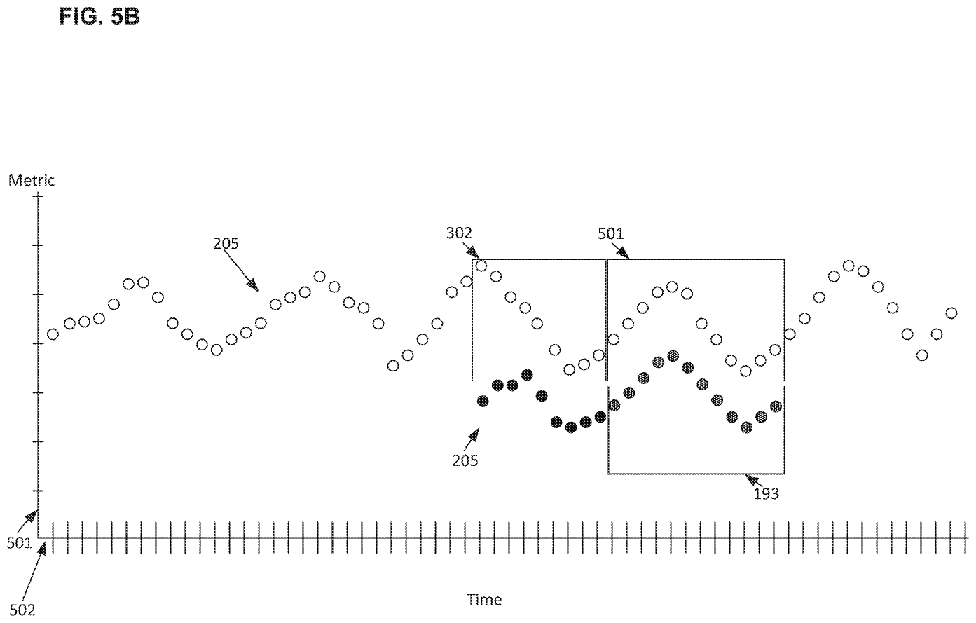

FIG. 5A shows an example visualization suitable for forecasting for time series with limited data according to an implementation of the disclosed subject matter. The time series comparer 110 may determine that the long-term time series 151 is the time series with the shortest distance between itself and the short-term time series 191 among all of the long-term time series and sections thereof in the repository 150. The long-term time series 151 may be sent to the time series forecaster 120 as the companion series to the short-term time series 191.

The time series forecaster 120 may generate forecasted data points 501 for the long-term time series 151. The forecasted data points 501 may be data points with forecasted, or predicted, measurements of the metric of the long-term time series 151 for future intervals of the long-term time series 151. The time series forecaster 120 may use any suitable form of forecasting or prediction to generate the forecasted data point 501 based on the data points 152 of the long-term time series 151. The time series forecaster 120 may generate any number of forecasted data points 501 for any suitable number of future intervals for the long-term time series 151.

The time series forecaster 120 may generate forecasted data points 193 for the short-term time series 191. The time series forecaster 120 may use the forecasted data points 501 generated for the long-term time series 151 to generate the forecasted data points 193 for the short-term time series 191. The time series forecaster 120 may, for example, scale or adjust the forecasted data points 501 based on properties of the short-term time series 191 to generate the forecasted data points 193. This may allow the time series forecaster 120 to generate the forecasted data points 193 when the short-term time series 191 does not have enough data points to use forecasting and prediction techniques that may be used on a time series with more data points, such as the long-term time series 151. The forecasted data points 193 may be stored with the short-term time series 191.

FIG. 5B shows an example visualization suitable for forecasting for time series with limited data according to an implementation of the disclosed subject matter. Alternatively, the time series comparer 110 may determine that the section 302 of the long-term time series 151 has the shortest distance between itself and the short-term time series 191 among all of the long-term time series and sections thereof in the repository 150. The long-term time series 151 may be sent to the time series forecaster 120 as the companion series to the short-term time series 191.

The time series forecaster 120 may use the data points from the long-term time series 151 in a section 502 that follow the data points in the section 302 instead of generating forecasted data points for the long-term time series 151. The data points in the section 502 may be data points with actual measurements of the metric of the long-term time series 151 for intervals of the long-term time series 151 that were the future relative to the data points in the section 302. The time series forecaster 120 may use any number of data points for any number of intervals of the long-term time series 151 after the last data point in the section 302.

The time series forecaster 120 may generate forecasted data points 193 for the short-term time series 191. The time series forecaster 120 may use the data points in the section 502 of the long-term time series 151 to generate the forecasted data points 193 for the short-term time series 191. The time series forecaster 120 may, for example, scale or adjust the data points in the section 502 based on properties of the short-term time series 191 to generate the forecasted data points 193. The forecasted data points 193 may be stored with the short-term time series 191.

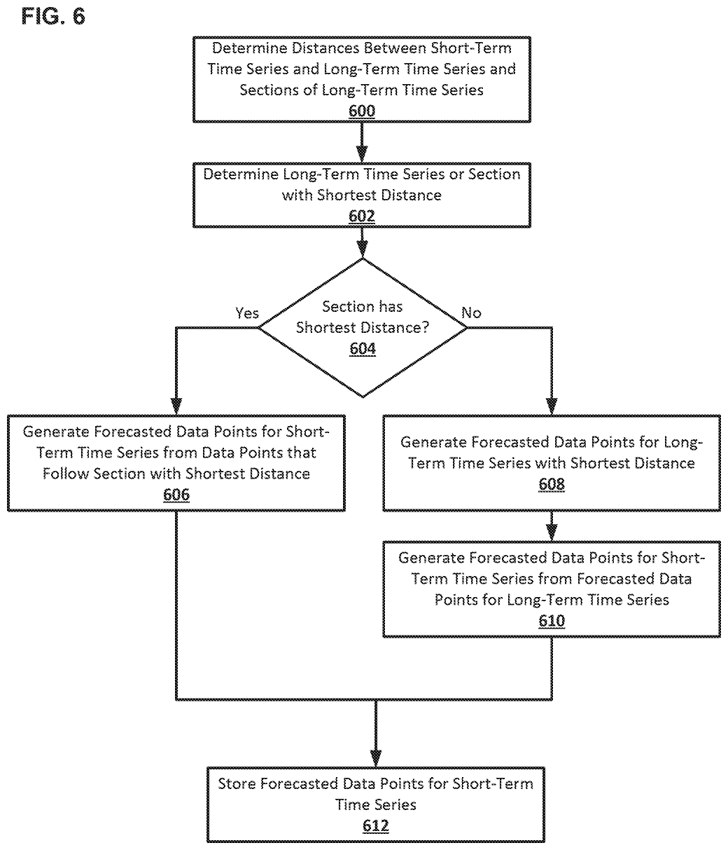

FIG. 6 shows an example procedure suitable for forecasting for time series with limited data according to an implementation of the disclosed subject matter. At 600, distances between short-term time series and long-term time series and sections of long-term series may be determined. For example, the time series comparer 110 may compare the short-term series 191 with the long-term time series 151, 161, 171, and 181, and sections of those time series, from the repository 150, to determine the distance between the long-term time series 151, 161, 171, and 181, and sections of those time series, and the short-term time series 191. The distances may be be based on the data points of the time series, for example, the data points 192 and the data points 152, 162, 172, and 182. The distances may be determined in any suitable manner, including, for example, Euclidean distance and Fréchet distance. Long-term series with large numbers of data points over a suitable period of time may have multiple sections compared with the short-term time series 191, for example, through time shifting the short-term time series 191 by an amount based on the intervals and seasonality or periodicity of the long-term time series. The time series comparer 110 may determine distances for all of the long-term time series in the repository 150, or may compare only those long-term series that use similar intervals to the short-term time series 191. For example, if the short-term time series 191 uses a monthly interval, the time series comparer 110 may determine the distance between the short-term time series 191 and long-term time series from the repository 150 that have monthly, weekly, biweekly, or bimonthly intervals, but not yearly or hourly intervals.

At 602, the long-term time series or section with the shortest distance may be determined. For example, the time series comparer 110 may compare the distances between the short-term time series 191 and the long-term time series and sections of long-term time series from the repository 150 to determine which long-term time series or section has the shortest distance between itself and the short-term time series 191. The long-term time series or section determined to have the shortest distance may be the companion series for the short-term time series.

At 604, if a section of a long-term time series has the shortest distance, flow may proceed to 606, otherwise, flow may proceed to 608. For example, the time series comparer 110 may determine that a section of a long-term time series from the repository 150, for example, the section 302 from the long-term time series 151, had the shortest distance between itself and the short-term time series 191, and flow may then proceed to 606. Otherwise, flow may proceed to 608 if a long-term time series has the shortest distance between itself and the short-term time series 191 based on the aligning the last data point in each time series.

At 606, forecasted data points for the short-term time series may be generated based on data points that follow the section with the shortest distance. For example, the time series comparer 110 may have determined that a section of a long-term time series, such as the section 302 of the long-term time series 151, had the shortest distance between itself and the short-term time series 191. The long-term time series which the section belongs to may be sent to the time series forecaster 120, with the section being identified as the companion series for the short-term time series 191. The time series forecaster 120 may generate forecasted data points for the short-term time series 191, such as the forecasted data points 193, based on the data points that follow the section that is the companion series in the long-term time series to which the section belongs. For example, the time series forecaster 120 may use data points the follow the section 302 of the long-term time series 151 to generate the forecasted data points 193, for example, scaling and adjusting the data points based on the short-term time series 191 and the data points 192.

At 608, forecasted data points for the long-term time series with the shortest distance may be generated. For example, the time series comparer 110 may have determined that a long-term time series, such as the long-term time series 151, had the shortest distance between itself and the short-term time series 191 based on alignment of the last data points in each series. The long-term time series with the shortest distance may be sent to the time series forecaster 120 as the companion series for the short-term time series 191. The time series forecaster 120 may generate forecasted data points for the long-term time series with the shortest distance, for example, the long-term time series 151, based on the data points for the long-term time series, for example, the data points 152. The time series forecaster 120 may use any suitable forecasting or prediction technique to generate the forecasted data points for the long-term time series, for example, forecasting or predicting measurements for the metric of the long-term time series for any suitable number of intervals into the future past the last data point in the long-term time series that has an actual measurement of the metric.

At 610, forecasted data points for the short-term time series may be generated based on forecasted data points for the long-term time series. For example, the time series forecaster 120 may generate forecasted data points for the short-term time series 191, such as the forecasted data points 193, based on the forecasted data points generated for the long-term series that had the shortest distance between itself and the short-term time series 191. For example, the time series forecaster 120 may use the forecasted data points generated for the long-term time series 151 to generate the forecasted data points 193, for example, scaling and adjusting the data points based on the short-term time series 191 and the data points 192.

At 612, the forecasted data points for the short-term time series may be stored. For example, the forecasted data points 193 generated by the time series forecaster 120 may be stored with the short-term time series 191 in the storage 140. The forecasted data points 193 may be stored in any suitable manner for any suitable amount of time, and may be used in any suitable manner, including, for example, displaying the forecasted data points 193 to a user in conjunction with, or separately from, the data points 192 of the short-term time series 191.

Embodiments of the presently disclosed subject matter may be implemented in and used with a variety of component and network architectures. FIG. 7 is an example computer system 20 suitable for implementing embodiments of the presently disclosed subject matter. The computer 20 includes a bus 21 which interconnects major components of the computer 20, such as one or more processors 24, memory 27 such as RAM, ROM, flash RAM, or the like, an input/output controller 28, and fixed storage 23 such as a hard drive, flash storage, SAN device, or the like. It will be understood that other components may or may not be included, such as a user display such as a display screen via a display adapter, user input interfaces such as controllers and associated user input devices such as a keyboard, mouse, touchscreen, or the like, and other components known in the art to use in or in conjunction with general-purpose computing systems.

The bus 21 allows data communication between the central processor 24 and the memory 27. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as the fixed storage 23 and/or the memory 27, an optical drive, external storage mechanism, or the like.

Each component shown may be integral with the computer 20 or may be separate and accessed through other interfaces. Other interfaces, such as a network interface 29, may provide a connection to remote systems and devices via a telephone link, wired or wireless local- or wide-area network connection, proprietary network connections, or the like. For example, the network interface 29 may allow the computer to communicate with other computers via one or more local, wide-area, or other networks, as shown in FIG. 8.

Many other devices or components (not shown) may be connected in a similar manner, such as document scanners, digital cameras, auxiliary, supplemental, or backup systems, or the like. Conversely, all of the components shown in FIG. 7 need not be present to practice the present disclosure. The components can be interconnected in different ways from that shown. The operation of a computer such as that shown in FIG. 7 is readily known in the art and is not discussed in detail in this application. Code to implement the present disclosure can be stored in computer-readable storage media such as one or more of the memory 27, fixed storage 23, remote storage locations, or any other storage mechanism known in the art.

FIG. 8 shows an example arrangement according to an embodiment of the disclosed subject matter. One or more clients 10, 11, such as local computers, smart phones, tablet computing devices, remote services, and the like may connect to other devices via one or more networks 7. The network may be a local network, wide-area network, the Internet, or any other suitable communication network or networks, and may be implemented on any suitable platform including wired and/or wireless networks. The clients 10, 11 may communicate with one or more computer systems, such as processing units 14, databases 15, and user interface systems 13. In some cases, clients 10, 11 may communicate with a user interface system 13, which may provide access to one or more other systems such as a database table 15, a processing unit 14, or the like. For example, the user interface 13 may be a user-accessible web page that provides data from one or more other computer systems. The user interface 13 may provide different interfaces to different clients, such as where a human-readable web page is provided to web browser clients 10, and a computer-readable API or other interface is provided to remote service clients 11. The user interface 13, database table 15, and processing units 14 may be part of an integral system, or may include multiple computer systems communicating via a private network, the Internet, or any other suitable network. Processing units 14 may be, for example, part of a distributed system such as a cloud-based computing system, search engine, content delivery system, or the like, which may also include or communicate with a database table 15 and/or user interface 13. In some arrangements, an analysis system 5 may provide back-end processing, such as where stored or acquired data is pre-processed by the analysis system 5 before delivery to the processing unit 14, database table 15, and/or user interface 13. For example, a machine learning system 5 may provide various prediction models, data analysis, or the like to one or more other systems 13, 14, 15.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A computer-implemented method performed by a data processing apparatus, the method comprising:
determining, by a computing device, for each of a plurality of long-term time series and sections in a repository, a distance between the long-term time series or section and a short-term time series comprising data points for measurements of a metric for a computer system;
determining, by the computing device, which of the long-term time series and sections from the repository has the shortest distance between that long-term series or section and the short-term time series;
generating, by the computing device, forecasted data points for the short-term time series based on the long-term time series or section determined to have the shortest distance between that long-term time series or section and the short-term time series, further comprising:
when the long-term time series or section determined to have the shortest distance between the long-term time series or section and the short-term time series comprises a section, and wherein the section is a section of a long-term time series from the repository, at least one of scaling and adjusting data points of the long-term time series of which the section is a section based on the short-term time series, wherein the data points follow the section in the long-term time series of which the section is a section to generate the forecasted data points for the short-term time series, and
when the long-term time series or section determined to have the shortest distance between the long-term time series or section and the short-term time series comprises a long-term time series from the repository, generating forecasted data points for the long-term time series based on data points of the long-term time series and at least one of scaling and adjusting the forecasted data points for the long-term time series based on the short-term time series to generate the forecasted data points for the short-term time series; and
storing, by the computing device, the forecasted data points for the short-term time series with the short-term time series in a storage of the computing device.

2. (canceled)

3. (canceled)

4. The method of claim 1, wherein determining, by a computing device, for each long-term time series and section in a repository, a distance between the long-term time series or section and a short-term time series comprises determining Euclidean distances or Fréchet distances.

5. The method of claim 1, wherein each section in the repository comprises a section of one of the long-term time series from the repository ending with a data point that is not the last data point in the one of the long-term time series from the repository.

6. The method of claim 1, wherein the forecasted data points for the short-term time series comprise forecasted measurements for a metric of the short-term time series.

7. The method of claim 1, wherein determining, by a computing device, for each long-term time series and section in a repository, a distance between the long-term time series or section and a short-term time series comprises aligning a last data point of a long-term time series or a last data point of a section with a last data point of the short-term time series.

8. The method of claim 1, wherein the long-term time series comprise more data points than the short-term time series.

9. A computer-implemented system comprising:
a storage, and
a processor that determines, for each of a plurality of long-term time series and sections in a repository in the storage, a distance between the long-term time series or section and a short-term time series comprising data points for measurements of a metric for a computer system,
determines which of the long-term time series and sections from the repository has the shortest distance between that long-term series or section and the short-term time series,
generates forecasted data points for the short-term time series based on the long-term time series or section determined to have the shortest distance between that long-term time series or section and the short-term time series by when the long-term time series or section determined to have the shortest distance between the long-term time series or section and the short-term time series comprises a section, and wherein the section is a section of a long-term time series from the repository, at least one of scaling and adjusting data points of the long-term time series of which the section is a section based on the short-term time series, wherein the data points follow the section in the long-term time series of which the section is a section to generate the forecasted data points for the short-term time series, and
when the long-term time series or section determined to have the shortest distance between the long-term time series or section and the short-term time series comprises a long-term time series from the repository, generating forecasted data points for the long-term time series based on data points of the long-term time series and at least one of scaling and adjusting the forecasted data points for the long-term time series based on the short-term time series to generate the forecasted data points for the short-term time series, and
stores the forecasted data points for the short-term time series with the short-term time series in the storage.

10. (canceled)

11. (canceled)

12. The system of claim 9, wherein the processor determines, for each long-term time series and section in a repository, a distance between the long-term time series or section and a short-term time series by determining Euclidean distances or Fréchet distances.

13. The system of claim 9, wherein each section in the repository comprises a section of one of the long-term time series from the repository ending with a data point that is not the last data point in the one of the long-term time series from the repository.

14. The system of claim 9, wherein the forecasted data points for the short-term time series comprise forecasted measurements for a metric of the short-term time series.

15. The system of claim 9, wherein the processor determines, for each long-term time series and section in a repository, a distance between the long-term time series or section and a short-term time series by aligning a last data point of a long-term time series or a last data point of a section with a last data point of the short-term time series.

16. The system of claim 9, wherein the long-term time series comprise more data points than the short-term time series.

17. A system comprising: one or more computers and one or more storage devices storing instructions which are operable, when executed by the one or more computers, to cause the one or more computers to perform operations comprising:
comprising:
determining for each of a plurality of long-term time series and sections in a repository, a distance between the long-term time series or section and a short-term time series comprising data points for measurements of a metric for a computer system;
determining which of the long-term time series and sections from the repository has the shortest distance between that long-term series or section and the short-term time series;
generating forecasted data points for the short-term time series based on the long-term time series or section determined to have the shortest distance between that long-term time series or section and the short-term time series further comprising:
when the long-term time series or section determined to have the shortest distance between the long-term time series or section and the short-term time series comprises a section, and wherein the section is a section of a long-term time series from the repository, at least one of scaling and adjusting data points of the long-term time series of which the section is a section based on the short-term time series, wherein the data points follow the section in the long-term time series of which the section is a section to generate the forecasted data points for the short-term time series, and
when the long-term time series or section determined to have the shortest distance between the long-term time series or section and the short-term time series comprises a long-term time series from the repository, generating forecasted data points for the long-term time series based on data points of the long-term time series and at least one of scaling and adjusting the forecasted data points for the long-term time series based on the short-term time series to generate the forecasted data points for the short-term time series; and
storing the forecasted data points for the short-term time series with the short-term time series.

18. (canceled)

19. (canceled)

20. The system of claim 17, wherein the instructions which are operable, when executed by the one or more computers, to cause the one or more computers to perform operations comprising determining, by a computing device, for each long-term time series and section in a repository, a distance between the long-term time series or section and a short-term time series further comprise instructions which are operable, when executed by the one or more computers, to cause the one or more computers to perform operations comprising aligning a last data point of a long-term time series or a last data point of a section with a last data point of the short-term time series.
